(19) United States
(12) Patent Application Publication
(10) Pub. No.: US 2023/0323972 A1
(43) Pub. Date: Oct. 12, 2023

(54) IMPROVEMENTS IN, OR RELATING TO, TRIGGER VALVES

(71) Applicant: Globalforce IP Limited, Auckland (NZ)

(72) Inventor: Timothy Walker, Hillsborough (NZ)

(73) Assignee: Globalforce IP Limited, Auckland (NZ)

(21) Appl. No.: 18/025,454

(22) PCT Filed: Sep. 10, 2021
(86) PCT No.: PCT/NZ2021/050162

§ 371 Date: Mar. 9, 2023

(30) Foreign Application Priority Data
Sep. 10, 2020 (NZ) 767885

(51) Int. Cl. F16K 17/04; F16K 31/122

(52) U.S. Cl. CPC F16K 17/0486; F16K 31/1221; F16K 31/1223; F16K 31/1226

(57) ABSTRACT

Disclosed is a trigger valve methods, use and apparatus. The valve has a housing enclosing, at least in part, a cavity. There is a trigger poppet including a poppet sealing portion at least in part within the cavity, the trigger poppet configured to receive an external input at, or toward, a receiving end thereof. A trigger piston including a primary sealing portion and a major face at least in part within the cavity, the trigger piston configured to receive high pressure fluid therethrough, the trigger piston having a minor face opposite the major surface and a secondary sealing portion. The trigger poppet and trigger piston are biased towards each other at least by the high-pressure fluid acting on the minor face, such that the high-pressure fluid is sealed from the cavity by the poppet sealing portion and primary sealing portion in sealing engagement on each other. The secondary sealing portion sealing against the housing, or part thereof, preventing release of the high-pressure fluid therefrom. The poppet sealing portion when displaced from the primary sealing portion by the external input unseals the sealing engagement and allows high pressure fluid to flow into the cavity and act on the major face causing the trigger poppet to move and unseats the secondary sealing portion from the housing, or part thereof, to allow flow of high pressure fluid to then do work, or cause work to be done.

### TECHNICAL FIELD OF THE INVENTION

The present invention relates to triggering and valving for pressurised fluid powered devices.

In particular, though not solely, the present invention is directed to apparatus and methods for triggering and valving for pressurised fluid powered devices, whether high or low pressure.

### BACKGROUND OF THE INVENTION

There are pressure systems that use a fluid, for example air or another gas, or a liquid, whether high or low pressure, to drive a workload. The workload may be a reciprocating piston, an ejected projectile or the pressure acts on an item with a pressure pulse. In such applications, there is the need to introduce the pressurised fluid into a region that can do the work on the workload, for example a working chamber. One such method to introduce the pressurised fluid to the workload is through a valve that directly or indirectly isolates the workload from a reservoir and the pressurised fluid source. The valve opens under action of an event, for example triggering by an external signal. Transfers the amount of high-pressure fluid to the workload, and then closes again, the high pressure fluid then does work. For example, the high-pressure fluid may then expand to drive the work load down the work chamber.

In high pressure applications, opening the valve is complex. The forces acting can be very large, and the time frames to open such valving are very small. This must all be done in a controlled repeatable manner to provide a reliable and efficient system that does the most work from the lowest volume of high-pressure fluid. This is particularly the case when a precise repeatable energy level must be delivered.

There is therefore a need to have a reliable, repeatable trigger system for these systems.

One such trigger system is that of Goodnature patent NZ 575339.

This uses a supply of compressed carbon dioxide gas in a replaceable cartridge. The trap has a blanked off vertically oriented kill zone which a ground dwelling or travelling, non-vertically curious animal must extend their head up and into, enticed by a bait in the kill zone. In doing so they disturb a fine steel whisker which acts as a trigger to release a portion of the carbon dioxide in a valve train, the final valve allowing a volume of carbon dioxide to drive a piston and in turn a hammer against the pest to incapacitate them.

This utilises a mechanical trigger to burp open a first pressure balanced membrane in the valve train which in turn burps open a second pressure balanced membrane in the valve train to then release high pressure fluid to activate a device, in that case a trap for pests.

One problem of such traps is that as the pressure of operation increases so too does the actuation force required for any trigger element which is not pressure balanced or force balanced by some means. When the operating pressure is many times the ambient pressure, the size of the relative forces to balance the system is too large to make a commercially useful trigger system by existing means. This causes problems when control of high pressure is needed in small devices.

A further shortcoming is the flexible nature of the diaphragms used in the valve train. These have a shortcoming, as the system the trigger valve is a part of must in some situations remain in a ready to fire state for some time, possibly weeks or months. The diaphragm based valve train over this time frame can leak and lead to firing of the system, and degassing of the operating fluid, which in turn at the very least results in a waste of propelling fluid, and may also create a risk to humans or animals. Diaphragms are also not suitable for very high-pressure operation, as is seen in many other high pressure applications such as pressure regulators for example, when pressures are above a certain level, piston and seal systems are used instead of diaphragms.

It is therefore desirable to have a self-resetting trap that can target multiple target species and go for long periods between maintenance and re-charging, that has high efficacy against a range of pests, is reliable and humane and has a range of common parts between its pest specific forms.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an It is an object of the present invention to provide an improved trigger valve for a pressurised fluid engine or device, or to provide a reliable, repeatable trigger valve for a pressurised fluid engine, or to overcome the above shortcomings or address the above desiderata, or to at least provide the public with a useful choice.

### BRIEF DESCRIPTION OF THE INVENTION

In a first aspect the present invention consists in a trigger valve, comprising or including,
A housing enclosing, at least in part, a cavity,
A trigger poppet including a poppet sealing portion at least in part within the cavity, the trigger poppet configured to receive an external input at, or toward, a receiving end thereof,
A trigger piston including a primary sealing portion and a major face at least in part within the cavity, the trigger piston configured to receive high pressure fluid therethrough, the trigger piston having a minor face opposite the major surface and a secondary sealing portion,
Wherein the trigger poppet and trigger piston are biased towards each other at least by the high-pressure fluid acting on the minor face, such that the high-pressure fluid is sealed from the cavity by the poppet sealing portion and primary sealing portion in sealing engagement on each other;
The secondary sealing portion sealing against the housing, or part thereof, preventing release of the high-pressure fluid therefrom, and
the poppet sealing portion when displaced from the primary sealing portion by the external input unseals the sealing engagement and allows high pressure fluid to flow into the cavity and act on the major face causing the trigger poppet to move and unseats the secondary sealing portion from the housing, or part thereof, to allow flow of high pressure fluid to then do work, or cause work to be done.

Preferably the work is in the form of the high-pressure fluid acting on a first external device, such as, but not limited to another surface, valve, dose valve, or similar.

Alternatively, or in addition, the trigger piston has a second end, opposite and distal from a first end that has the primary sealing portion, that can act on the first external, or a second external device.

Preferably the second end can act as a hammer to impact on the first, or second, external device.

Preferably the trigger piston moves in a first direction within the cavity.

Preferably the trigger poppet moves in a second direction within the cavity.

Preferably the first direction and second direction are parallel to each other.

Preferably the major face and minor face are each perpendicular to the first direction.

Preferably the receiving end is distal from the primary sealing portion.

Preferably the trigger poppet is surrounded by, and the cavity filled by, ambient pressure, which may be atmospheric, environmental or another reference pressure when in sealing engagement.

Preferably the trigger piston and, or the trigger poppet, are further biased toward the sealing engagement by one or more biasing elements, such as, but not limited to a spring, or other elastic element, whether in tension or compression.

Preferably the cavity includes one or more leak paths from an interior thereof to an exterior thereof, such as, but not limited to bleed ports, or less than perfect sealing about the trigger poppet, trigger piston, or parts thereof.

Preferably the primary sealing portion is an endless knife edge and the poppet sealing portion seals thereto, either or both being a resilient material to at least in part conform and seal to the other, or vice versa.

Preferably there is a pilot port through the trigger piston to within a sealing periphery formed between the primary sealing portion and poppet sealing portion.

Preferably a sealing area contained within the sealing periphery creates a first force from the high-pressure fluid, that is less than a second force created by the bias acting on the trigger poppet, such that the sealing engagement is maintained.

Preferably there is a third force from the high-pressure fluid acting on the minor face including with any further bias, when in sealing engagement.

Preferably the second force and third force drive the two portions together to form the sealing engagement.

Preferably the high-pressure fluid creates a fourth force when acting on the major face that is greater than the third force including any further bias.

Preferably the high-pressure fluid is fed from a high-pressure fluid volume.

Preferably the high-pressure fluid volume is supplied from a high-pressure fluid source, either constantly, or selectively.

Preferably the selective supply is closed, or closes, when the sealing engagement is unsealed, and, or when the secondary sealing portion is unseated.

Alternatively, the constant supply from the high-pressure fluid source is at a first flow rate that is lower than a second flow rate when the sealing engagement is unsealed and, or the secondary sealing portion is unseated.

Preferably the high-pressure fluid is in the range of 10 to 50 bar, and preferably at about 16 bar.

Preferably the interior of the cavity can exhaust high pressure fluid back through the pilot port into the high-pressure volume when unsealed. This provides a possible alternative where the piston comes down flow into the area could get blocked—so bleed could be only at top—main one through piston may be blocked as piston moves down it would block itself.

Preferably the high pressure fluid pressure acting on the major face will reduce after unsealing, as the high pressure fluid does work when the secondary sealing portion is unseated, such that the fourth force reduces to below the third force, allowing the trigger piston to be biased back towards sealing engagement.

Preferably unseating of the secondary sealing portion allows the high-pressure fluid to vent to ambient.

Preferably the trigger poppet is driven in the second direction, opposite to the first direction, when unsealed, by the high-pressure fluid, acting on the poppet sealing portion.

Preferably the trigger poppet has at least a first partial seal where any part of it extends beyond the cavity.

Preferably the trigger piston has at least a second partial seal between a periphery thereof and the interior of the cavity.

In another aspect the present invention consists in a trigger valve, comprising or including,
A valve body, with an interior thereof defining a cavity,
A trigger poppet, at least in part located within the cavity,
A trigger piston, at least in part located within the cavity,

The trigger poppet and the trigger piston having,
first positions where they are biased to be in sealing engagement with each other, such that a supply of high-pressure fluid is prevented from entering between them, and
second positions where receipt of an external input unseals the sealing engagement, the high-pressure fluid can enter between them, forcing them apart, such that a flow of high pressure fluid is released to then do work, or cause work to be done, on an external device.

In another aspect the present invention consists in a trigger valve that operates on a high-pressure fluid, comprising or including,
A valve housing, the valve body defining a pressure cavity,
A primary trigger poppet that can receive an external input, and having a first poppet sealing surface or portion located within the pressure cavity,
A secondary trigger piston that can act on an external device, and having a primary sealing surface or portion, the secondary trigger piston can receive a source of the high pressure fluid, which high pressure fluid is sealed at a sealing engagement of the first poppet sealing surface, and primary sealing surface,
the primary trigger poppet and secondary trigger piston biased towards sealing engagement at the first poppet sealing surface, and primary sealing surface,
upon receipt of the external input the first poppet sealing surface is displaced from the sealing engagement, and the high-pressure fluid can flow into an interior of the pressure cavity to then displace the secondary trigger piston to then act, or cause an action, on the external device.

In another aspect the present invention consists in a method of operation of a trigger valve, comprising or including the steps of,
Providing a housing having a cavity therein, at least in part within which there is a trigger poppet, and a trigger piston,
Biasing the trigger poppet and the trigger piston at least in part by a high pressure fluid such that in a first position they are in sealing engagement with each other so that the high pressure fluid is prevented from moving between them, and wherein a flow of high pressure fluid is prevented from exiting the housing, or part thereof,
Disturbing the trigger poppet, and or the trigger piston by an external input such that the they move to a second position where high pressure fluid can flow therebetween and drive them apart,
allowing the flow of high-pressure fluid, when the trigger poppet and or the trigger piston move to or toward the second position, to exit the housing, or part thereof,
working on an external device by the flow of high pressure exiting the housing, or part thereof,
exhausting the high-pressure fluid between the trigger poppet and trigger piston such that the trigger poppet and, or trigger piston can return, under the, or another bias, to the first position,
such that the trigger valve allows, or causes, an instance of work to be done by the high-pressure fluid on an external device, in response to an external input, and thereafter reset itself in preparation for a further external input.

Preferably the work is in the form of the high-pressure fluid acting on a first external device, such as, but not limited to another surface, valve, dose valve, or similar.

Alternatively, or in addition, the trigger piston has a second end, opposite and distal from a first end that has the primary sealing portion, that can act on the first external, or a second external device.

Preferably the second end can act as a hammer to impact on the first, or second, external device.

Preferably the trigger piston moves in a first direction within the cavity.

Preferably the trigger poppet moves in a second direction within the cavity.

Preferably the first direction and second direction are parallel to each other.

Preferably the major face and minor face are each perpendicular to the first direction.

Preferably the receiving end is distal from the primary sealing portion.

Preferably the trigger poppet is surrounded by, and the cavity filled by, ambient pressure, which may be atmospheric, environmental or another reference pressure when in sealing engagement.

Preferably the trigger piston and, or the trigger poppet, are further biased toward the sealing engagement by one or more biasing elements, such as, but not limited to a spring, or other elastic element, whether in tension or compression.

Preferably the cavity includes one or more leak paths from an interior thereof to an exterior thereof, such as, but not limited to bleed ports, or less than perfect sealing about the trigger poppet, trigger piston, or parts thereof.

Preferably the primary sealing portion is an endless knife edge and the poppet sealing portion seals thereto, either or both being a resilient material to at least in part conform and seal to the other, or vice versa.

Preferably there is a pilot port through the trigger piston to within a sealing periphery formed between the primary sealing portion and poppet sealing portion.

Preferably a sealing area contained within the sealing periphery creates a first force from the high-pressure fluid, that is less than a second force created by the bias acting on the trigger poppet, such that the sealing engagement is maintained.

Preferably there is a third force from the high-pressure fluid acting on the minor face including with any further bias, when in sealing engagement.

Preferably the second force and third force drive the two portions together to form the sealing engagement.

Preferably the high-pressure fluid creates a fourth force when acting on the major face that is greater than the third force including any further bias.

Preferably the high-pressure fluid is fed from a high-pressure fluid volume.

Preferably the high-pressure fluid volume is supplied from a high-pressure fluid source, either constantly, or selectively.

Preferably the selective supply is closed, or closes, when the sealing engagement is unsealed, and, or when the secondary sealing portion is unseated.

Alternatively, the constant supply from the high-pressure fluid source is at a first flow rate that is lower than a second flow rate when the sealing engagement is unsealed and, or the secondary sealing portion is unseated.

Preferably the high-pressure fluid is in the range of 10 to 50 bar, and preferably at about 16 bar.

Preferably the interior of the cavity can exhaust high pressure fluid back through the pilot port into the high-pressure volume when unsealed. This provides a possible alternative where the piston comes down flow into the area could get blocked—so bleed could be only at top—main one through piston may be blocked as piston moves down it would block itself.

Preferably the high pressure fluid pressure acting on the major face will reduce after unsealing, as the high pressure fluid does work when the secondary sealing portion is unseated, such that the fourth force reduces to below the third force, allowing the trigger piston to be biased back towards sealing engagement.

Preferably unseating of the secondary sealing portion allows the high-pressure fluid to vent to ambient.

Preferably the trigger poppet is driven in the second direction, opposite to the first direction, when unsealed, by the high-pressure fluid, acting on the poppet sealing portion.

Preferably the trigger poppet has at least a first partial seal where any part of it extends beyond the cavity.

Preferably the trigger piston has at least a second partial seal between a periphery thereof and the interior of the cavity.

In another aspect the present invention consists in a trigger valve as described herein with reference to any one or more of the accompanying drawings.

In another aspect the present invention consists in a method of operating of a trigger valve as described herein with reference to any one or more of the accompanying drawings.

In another aspect the present invention consists in a device incorporating a trigger valve as herein described with reference to any one or more of the accompanying drawings.

As used herein the term “and/or” means “and” or “or”, or both.

As used herein “(5)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be in any sense limiting.

Other aspects of the invention may become apparent from the following description which is given by way of example only and with reference to the accompanying drawings.

### BRIEF DESCRIPTION OF THE DRAWINGS

Preferred forms of the present invention will now be described with reference to the accompanying drawings in which;

FIG. 1 Shows a cross sectional view of a trigger valve in keeping with the present invention with the trigger valve in a set or resting, ready to be triggered, configuration, charged with high pressure fluid, and surrounded by ambient (lower pressure) lower pressure fluid,

FIG. 2 Shows the same view as FIG. 1, but where the trigger has received an external input and has been activated,

FIG. 3 Shows a similar view to that of FIG. 2, but where the trigger valve is further through its actuation, the trigger poppet is displaced further upwards, the trigger piston is displaced further downwards to perform its external actuation,

FIG. 4 Shows a cross sectional view of a trigger valve as per FIG. 1 with the trigger valve in a set or resting, ready to be triggered, configuration, charged with high pressure fluid, and surrounded by ambient (lower pressure) lower pressure fluid, showing the location of the high pressure fluid and ambient or reference pressure fluid,

FIG. 5 Shows the same view as FIG. 4, but where the trigger has received an external input and has been activated, showing the location of the high pressure fluid and ambient or reference pressure fluid,

FIG. 6 Shows a similar view to that of FIG. 5, but where the trigger valve is further through its actuation, the trigger poppet is displaced further upwards, the trigger piston is displaced further downwards to perform its external actuation, showing the location of the high pressure fluid and ambient or reference pressure fluid,

FIG. 7 Shows a similar view to that of FIG. 6, where the two trigger members have travelled to their further extents, the high pressure fluid is purged and the ambient or reference fluid is now reducing the high pressure, the biases are now taking over to return the trigger piston toward the set or resting configuration, showing the location of the high pressure fluid and ambient or reference pressure fluid,

FIG. 8 Shows a similar view to that of FIG. 7, where the two trigger members with close to equal pressure on their sides and the trigger piston is returned to its set or resting configuration, showing the location of the high pressure fluid and ambient or reference pressure fluid,

FIG. 9 Shows a similar view to FIG. 8, where the trigger poppet can now return to its set or resting configuration, showing the location of the high pressure fluid and ambient or reference pressure fluid,

FIG. 10 Shows the same view as that of FIG. 9, but with pressure in the trigger piston starting to build again and increase the sealing force against the trigger poppet, showing the location of the high pressure fluid and ambient or reference pressure fluid,

FIG. 11 Shows the trigger valve now back in a set or resting configuration, ready to be triggered again, showing the location of the high pressure fluid and ambient or reference pressure fluid,

FIG. 12 Shows a plan view of a device incorporating the present invention, in this case the trigger valve of the present invention activates a piston driven by high pressure air, the piston in turn is connected to an impactor, the device being a pest control device that is triggered by the pest entering a region and triggering the trigger valve,

FIG. 13 is a side view of the device of FIG. 12 in vertical cross-section showing the layout of the trigger valve, and subsequent device components it controls and activates,

FIG. 14 is a detail view from FIG. 13, again in vertical cross-section showing the trigger valve of the present invention in resting state ready to be triggered, and various surrounding elements of the device it controls and activates,

FIG. 15 Shows a view of the present invention with an external input to trigger it,

FIG. 16 Shows a plan view of the trigger piston and the primary sealing portion, showing the pilot port and knife edge,

FIG. 17 Shows a bottom view of the tripper poppet, and the poppet sealing portion, and in dashed line the sealing periphery the knife edge forms when in sealing engagement with the trigger piston,

FIG. 18 Shows a second variation of the trigger valve in isometric side view,

FIG. 19 Shows an isometric vertical cross-section of the trigger valve of FIG. 18 in a set or resting, ready to be triggered configuration, charged with high pressure fluid, and surrounded by ambient, or lower pressure fluid, similar to the variation in FIG. 1,

FIG. 20 Shows a vertical cross-section of the trigger valve of FIG. 19 again in a set or resting, ready to be triggered configuration, charged with high pressure fluid, and surrounded by ambient, or lower pressure fluid, similar to the variation in FIG. 1,

FIG. 21 Shows the vertical cross section of FIG. 20 showing the distribution of high-pressure fluid internally (dark or brown colour), and ambient fluid (light or blue colour) internally (though also surrounding the trigger valve), similar to that of FIG. 4,

FIG. 22 Shows the vertical cross section of FIG. 20, just as the trigger valve has received an external input and has been activated, similar to that shown in FIG. 2,

FIG. 23 Shows the pressure distribution in the trigger valve shown in FIG. 21 just after it has received the external input, showing the distribution of high pressure fluid internally (dark or brown colour), and ambient fluid (light or blue colour) internally (though also surrounding the trigger valve), similar to that of FIG. 5,

FIG. 24 Shows the next step on from FIGS. 22 and 23 (but with no colours) with both the trigger poppet and trigger piston moving away from each other under action of the high pressure, similar to FIG. 6 (but with no colouring), the high pressure is open to vent to ambient as the secondary sealing portion is now open,

FIG. 25 Shows a cross section of FIG. 23 but where the two trigger members have travelled to their further extents vertically, and is coloured pressure distribution of FIG. 24, the high pressure is open to vent to ambient as the secondary sealing portion is now open,

FIG. 26 Shows a similar view to FIG. 25 but where the high pressure fluid is reducing (lighter or yellow colour) in pressure as it bleeds to ambient or reference pressure (light or blue colour), the biases are now taking over to return the trigger piston and the trigger poppet toward the set or resting configuration, similar to FIG. 7, the high pressure is still open to vent to ambient as the secondary sealing portion is now open,

FIG. 27 Shows the same cross section as FIG. 26 but with the biases moving the two trigger members back together, the showing the location of the reduced high pressure fluid (in green) and ambient or reference pressure fluid (in blue), the high pressure is now closed and unable to vent at high volume to ambient, as the trigger piston has moved up sufficient to close the secondary sealing portion,

FIG. 28 Shows in vertical cross section the various bleed paths available to allow the charge of high pressure fluid that was present between the poppet and piston to escape to lower or ambient pressure, after the secondary sealing portion is sealed (shown in FIG. 27), to this allow the trigger members to come back to the resting position under action of the biases,

FIG. 29 Shows the trigger valve now back in a set or resting configuration, ready to be triggered again, showing the location of the high-pressure fluid (dark or brown) and ambient or reference pressure fluid (light or blue), the high pressure (dark or and brown),

FIG. 30 Shows a similar view to that of FIG. 20, but with an additional trigger poppet seal, used for example when the external trigger actuation may be low enough to break the seal but only for a small leak that would otherwise not trigger the valve,

FIG. 31 Shows a similar view to that of FIG. 32 and a blocking portion that prevents movements of the trigger piston to add a safety for example when undergoing maintenance or as a lock out, and

FIG. 32 Shows a similar view to that of FIG. 20 with a pilot sealing portion that prevents high pressure fluid rushing out the pilot port when the trigger piston is open as shown.

### DETAILED DESCRIPTION OF THE INVENTION

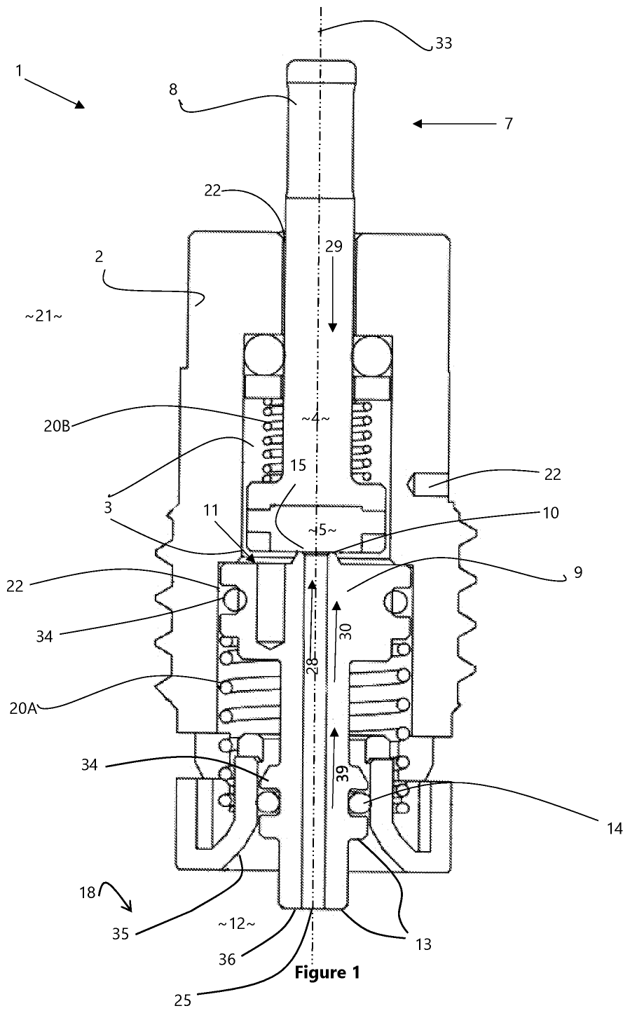

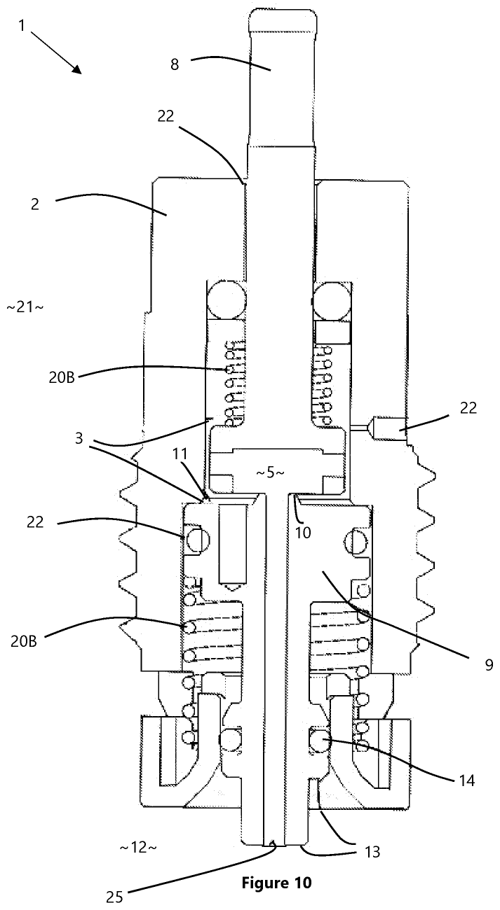

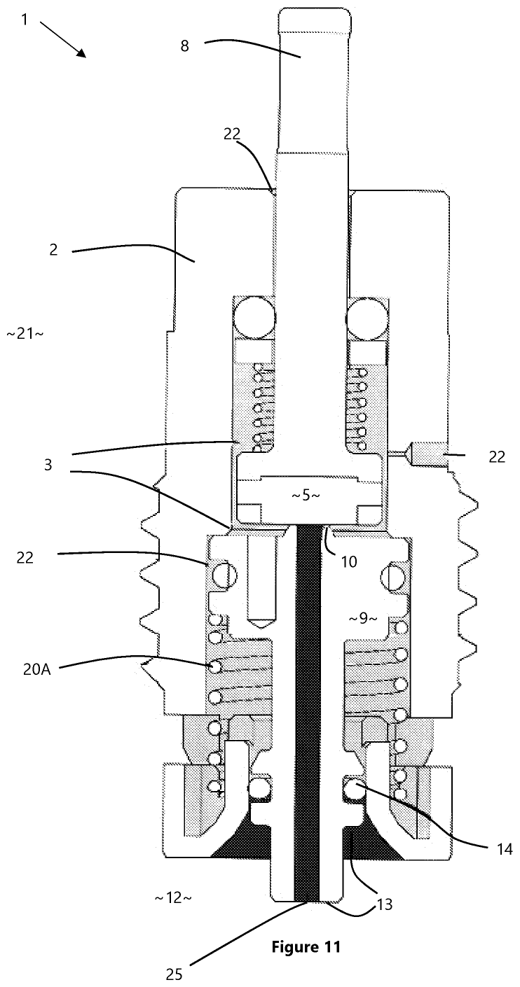

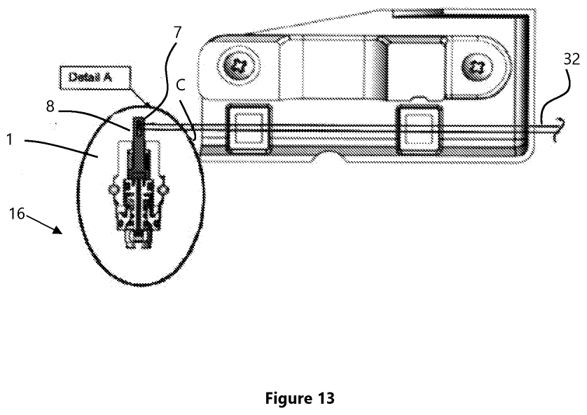

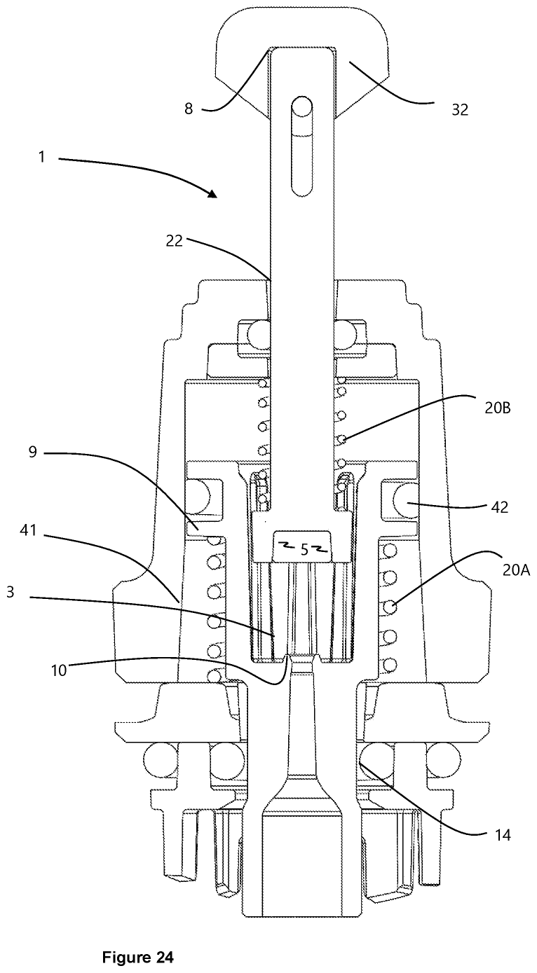

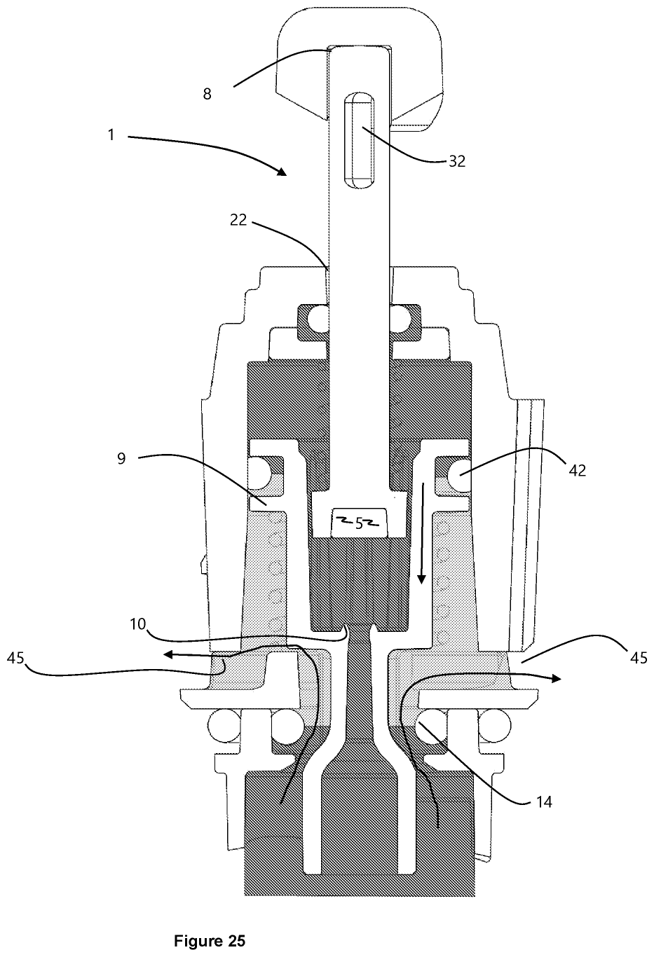

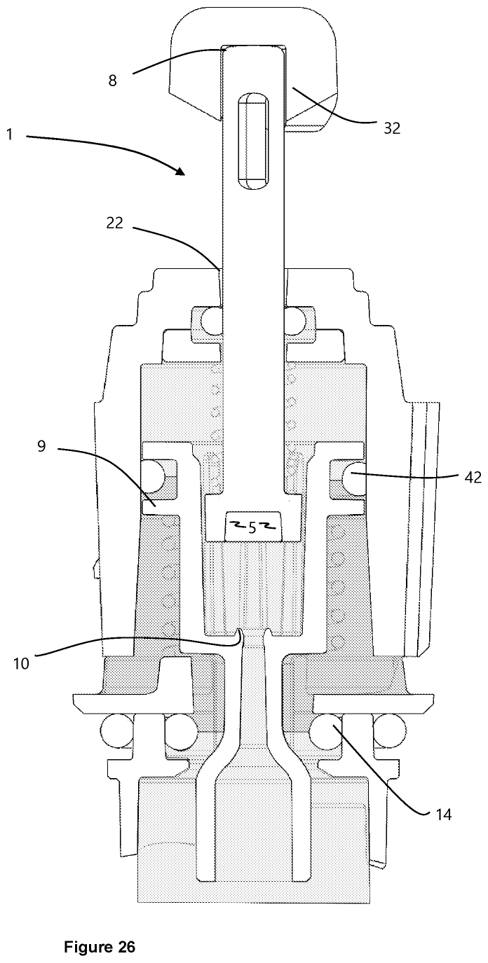

Preferred embodiments and their implementation in an example product will now be described with reference to FIGS. 1 through 32.

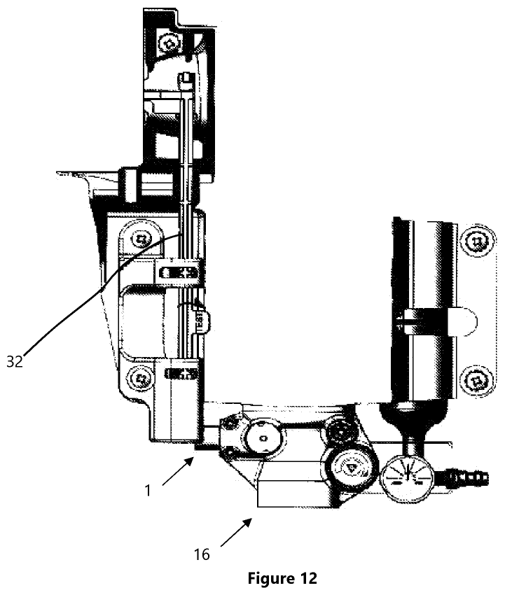

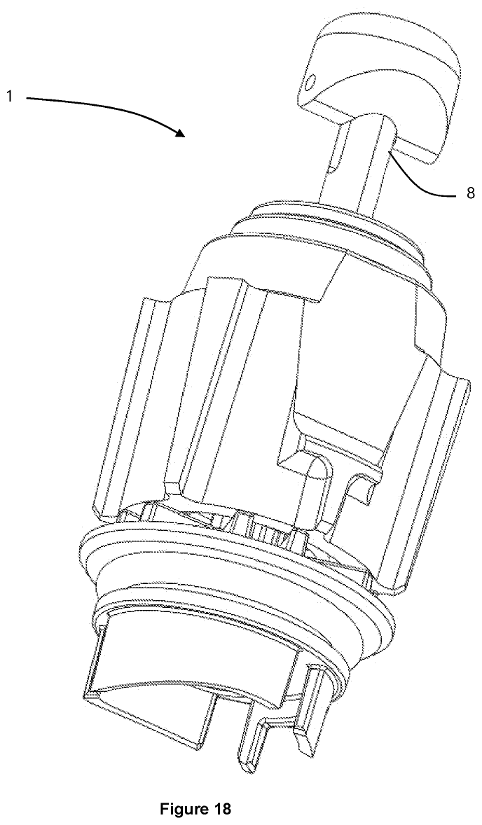

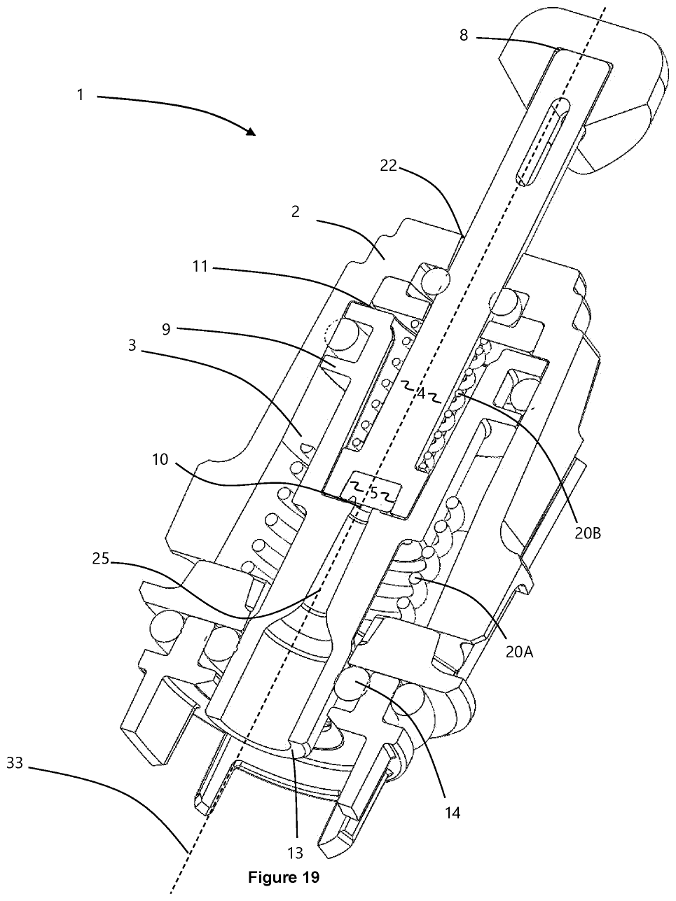

A first variation is shown in FIGS. 1 through 11, a second variation is shown in FIGS. 18 through 29, and a product, in this case a trap, utilising the trigger is shown in FIGS. 12 through 17.

A trigger valve 1 to operate with, and control, a high-pressure fluid 12 relative to a reference or ambient fluid 21 is shown in FIG. 1, and a geometrical variation in FIGS. 18 and 19. Actual pressures of the high pressure fluid and reference or ambient fluid may change over the course of operation of the trigger valve 1, as for example the high pressure fluid mixes with the lower pressure ambient fluid. It is understood the key difference between the high pressure fluid and the ambient or reference fluid is such that there is a pressure difference between them from which work can be extracted, or an action performed due to the pressure difference.

Where the term fluid is used here this may be a gas, for example, but not limited to air, nitrogen, carbon dioxide, or any other gas whether pure or a mixture, or it may be a fluid, for example but not limited to water, hydraulic oil or other fluid, whether compressible or not. By way of example only when using air as the high pressure fluid, and likewise the ambient fluid, at a lower pressure, in this case as atmospheric pressure the high pressure fluid may be at a range of 10 to 100 bar, preferably 16 bar, and the lower pressure would be at atmospheric, that is about 1.013 bar at sea level.

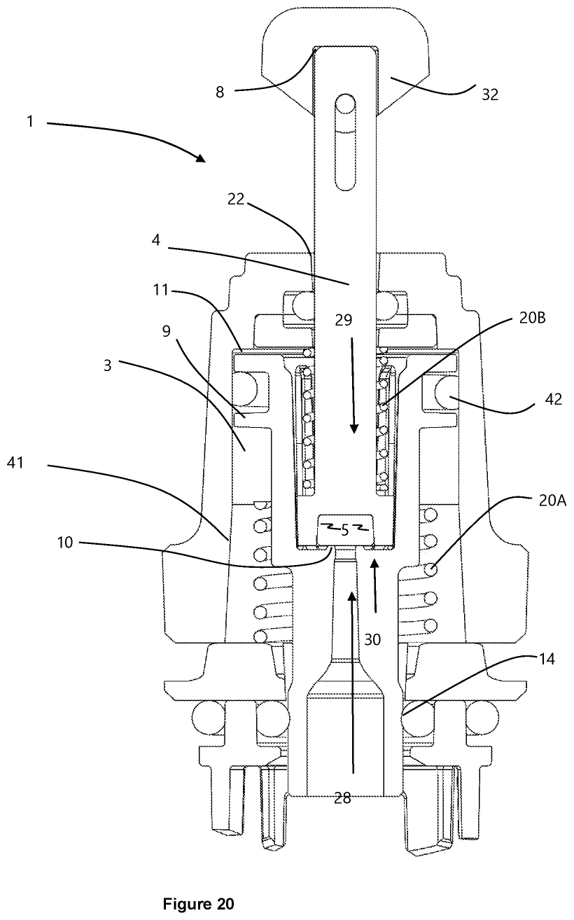

The trigger valve 1 consists of a housing 2, which defines within its interior a cavity 3 as shown in FIGS. 1, 19 and 20. Within the cavity 3 are the co-operating portions of a trigger poppet 4 and a trigger piston 9. The cross sections of the cavity 3, trigger poppet 4 and trigger piston 9 are complimentary so the trigger poppet 4 and trigger piston 9 can translate, for example along the major axis 33 of the trigger valve 1. In the embodiment shown the cavity 3, trigger poppet 4 and trigger piston 9 are circular in cross section, and the cavity 3, as seen in FIG. 1 for example has a varying diameter over its length from bottom to top. A taper 22 is present in the variation shown in FIG. 20 (and onwards) the cavity 3 has a pronounced throat 41 that tapers outward towards the bottom. The function of this will be described later, but it enables a gradual seal to occur to the trigger piston seal 42 as it moves back to the set position.

The sizes of the trigger poppet 4 outer diameter relative to the inner diameter of the cavity can be used to tune the trigger valve performance also, for example its reaction time, time open, and time to close. A very close match will mean a slow opening of the trigger poppet 4 due to the creation of back pressure (which can be tuned by any leak path), and possibly a slow return (again tunable by leak path, such as any of those shown in FIG. 28) if pressure behind the trigger poppet 4 is lower than in front of it. These differences in diameter and leak path size also will have different effects due to the dynamic nature of the trigger valve, it can be very fast acting, very slow acting and the viscosity of the fluid also used for example to slow or speed it up.

For example an open and close cycle of the trigger valve 1 from resting, open and return to resting may be in the range of 1 millisecond to 1000 milliseconds, and for the application of triggering a device such as a pest control device may be 20 to 500 milliseconds when a compressed gas such as air or carbon dioxide is used.

The external shape of the housing 2 will depend on the application and therefore may be circular, square, rectangular or other shape as needed.

The trigger poppet 5 and trigger piston 10 may be made from any resilient material such as, but not limited to plastic, metal, composite or other material and may be made by moulding, co- or over-moulding, machining, forging, or additive manufacturing such as three dimensional printing, or any combination thereof.

In the form for use with the fluid which is compressed carbon dioxide or air the trigger poppet 5 and trigger piston 10 have bodies made from plastic and are manufactured by moulding. However, other materials may be used for the same, or when the fluid is different, taking into account the requirements of the fluid and the operating environment, for example temperature, operating pressures, sealing pressures, sealing materials, and whether there is, or likely to be contamination of the operating fluid, for example entrained particles.

The trigger valve 1 has a poppet sealing portion 5 shown for example in FIGS. 1 and 20. In the preferred embodiment this is made of a resilient material to conform to the primary sealing portion 10 of the trigger piston 9 to enable sealing engagement 15 therewith, described later. In the preferred form the poppet sealing portion 5 is co-moulded or over moulded to the body of the trigger poppet 4. In the preferred form the poppet sealing portion is a co-moulding of a ˜70A elastomer (rubber or polyurethane) material, moulded into, onto, or about a harder plastic part of the trigger poppet. This forms a soft “face seal” on the poppet sealing portion that is over-moulded into the harder trigger poppet body.

However, in other forms it may be a more rigid material and the primary sealing portion 10 may be the compliant material of the sealing engagement. In other forms the poppet sealing portion 5 and the primary sealing portion 10 may be of similarly resilient or compliant materials.

The poppet sealing portion 5, may also extend out the sides of the trigger poppet 4, and form additional sealing of the tripper poppet 4 with the cavity as seen in FIG. 1.

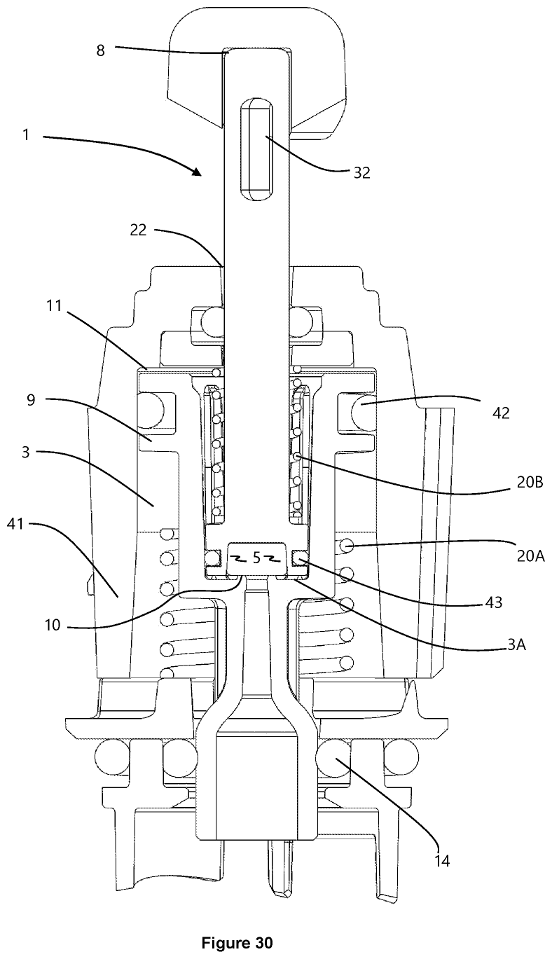

In FIG. 30 a minor variation of the trigger poppet 4 is shown. Whilst otherwise the trigger valve is the same as earlier described the tripper poppet 4 as shown has an additional seal 40 that seals off the cavity 3A. This minor variation shown in FIG. 30 has an additional trigger poppet seal 43 is shown—in this case as an o-ring, but it may also be a knife edge seal or other suitable seal between the trigger poppet and the inside diameter of the cavity 3. This may be used to increase the sensitivity of the trigger valve 1. For example should the external input be sufficient to break the seal between the primary sealing portion 10 and the poppet sealing portion 5 such that a slow leak occurs, but would otherwise not be sufficient to trigger the valve, then the presence of seal 43 will allow fluid pressure to build in the void or cavity 3A defined by the seal 43 and the major face 11 and that region of the poppet sealing portion 5 facing the major face. When that pressure builds to the activation pressure the trigger valve 1 will then actuate. Again this can be used to tune the response of the trigger valve 1, for example by controlling the rate of movement of the trigger poppet 4 on moving from the set position and returning to the set position.

The trigger poppet 4 and trigger piston 10, are both partially contained within the cavity 3 of the housing 2 as seen in FIGS. 1 and 20. The trigger poppet 4 has a receiving end 8 that is connected to, or can receive, an external input 7, such as a trigger bar 32 or otherwise to actuate the trigger valve 1. The trigger poppet 4 has a poppet sealing portion 5, in sealing engagement with the primary sealing portion 10 of the trigger piston 9. The sealing engagement can be disengaged upon receiving the external input causing movement of the trigger poppet 4 or trigger piston 10 relative to each other. In another form the trigger valve 1 may be triggered by the high pressure fluid 12 exceeding a desired threshold. Should this occur then the trigger valve 1 will actuate as described later below and vent the high pressure fluid 12. In this way the trigger valve 1 can act as a pressure release valve to prevent or reduce an over pressure event in the high pressure fluid supplied to it.

In the embodiment shown in FIGS. 1 through 11, and 19 through 30 there is a first bias 20B acting on the trigger poppet 4. This acts to bias the trigger poppet 4 toward the trigger piston 5. In other embodiments such bias may be due to pressure acting on the backside of the trigger poppet, or may be gravity, magnetic or other suitable bias.

The receiving end 8 is formed if needed to engage with the external input 7. In the embodiment shown this is a loop within which a portion of the external input 7 bear. The effect being, the external input 7 (described in more detail later) will disturb the trigger poppet 4 and break the sealing engagement 15.

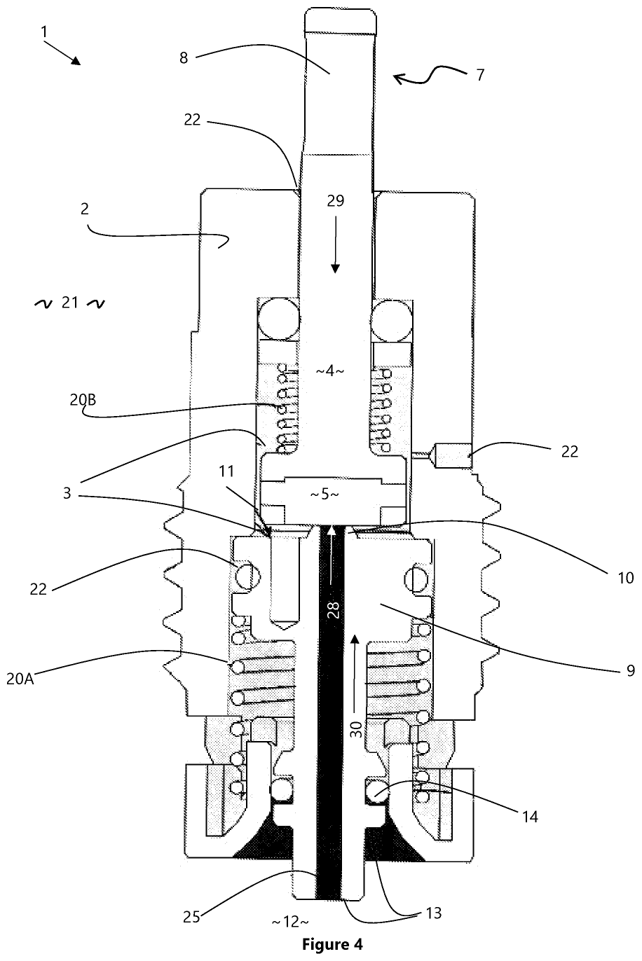

The receiving end 8 as shown extends from the cavity 3 to outside the housing 2. The aperture through which the receiving end 8 extends can be tuned to provide a leak path 22, better seen in FIG. 4 and leak path 3 in FIG. 28. Such tuning may be used to control the speed with which the trigger poppet 4 moves away under the initial external input 7, as well as the speed of movement after triggering, and also the return back to the ready position. The tuning may be achieved by the size of the aperture, as well as sealing elements around the receiving end 8 and any friction they may apply and any restrictions leading to the leak path or paths. Such tuning therefore can control the sensitivity of the trigger valve 1 as well as the speed with which it opens.

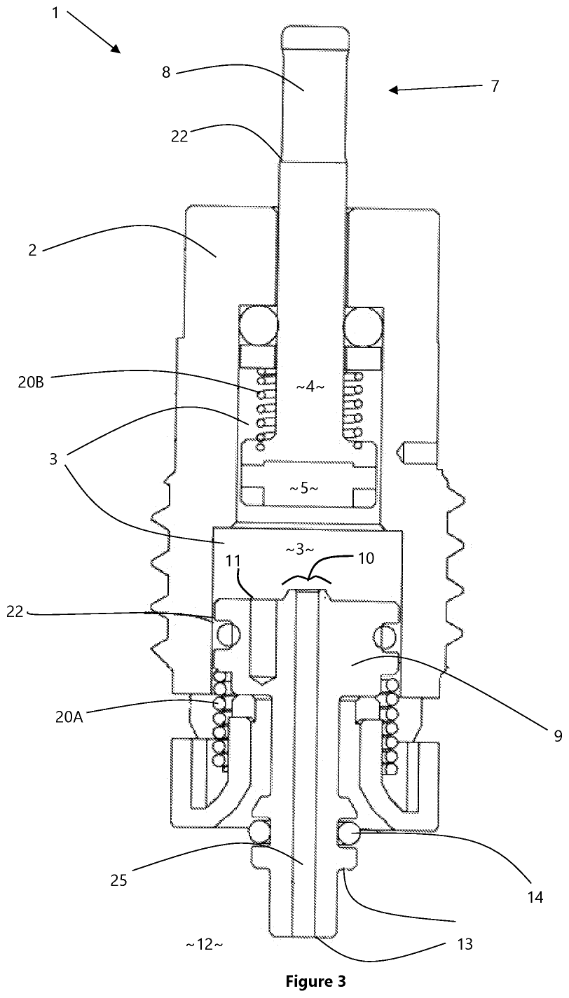

There leak paths 22 in FIGS. 4 and 3 in FIG. 28 can be used to tune the trigger valve 1 response, for example by tuning the initial back pressure the trigger poppet 4 will see when starting its movement.

The leak paths 22 in FIGS. 4, and 1 through 5 in FIG. 28 shown also ensure that there is no remaining pressure above the trigger piston in the event it closes before all pressure in the housing is evacuated to atmosphere. They also “equalise” the cavity 3 pressure with atmosphere. This will allow for heating or cooling of the cavity 3 and any pressure fluctuations that may possibly could cause an inadvertent opening of the trigger valve 1, thus reducing or removing the chance of the trigger valve 1 actuating or firing the device.

The trigger piston 9 has a primary sealing portion 10 that faces the poppet sealing portion 5 of the trigger poppet 4 shown in FIGS. 4 and 20.

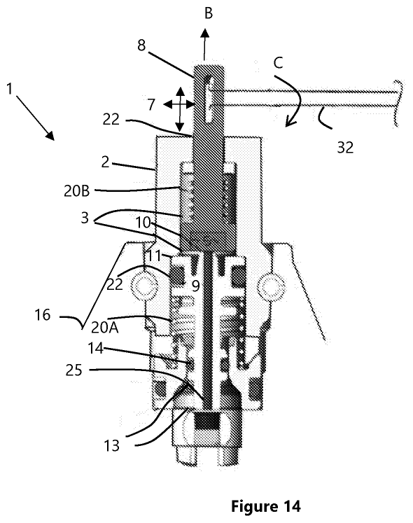

In the preferred embodiment the primary sealing portion 10 is a face of the trigger piston and is therefore the same material. This may be substantially planar as shown in FIGS. 1 through 11, and 20 through 30 or have a relief of similar as shown in FIG. 14. As described above the poppet sealing portion 5 is made of a compliant material to conform, and seal to, the primary sealing portion 10. However, as described above it may be the other way round, or the two materials may be equally or similarly resilient as the application of the trigger valve 1 requires. The poppet sealing portion 5 and or the primary sealing portion 10 (when not unitary with the trigger piston 9) may be replaceable also, for example for maintenance purposes. It may require disassembly of the trigger poppet, or similar be able to be pulled out and a new one pushed in using a friction fit, such as what would be achievable in the configuration of FIG. 14, or to alter the sensitivity and include the additional seal 43 shown in FIG. 30.

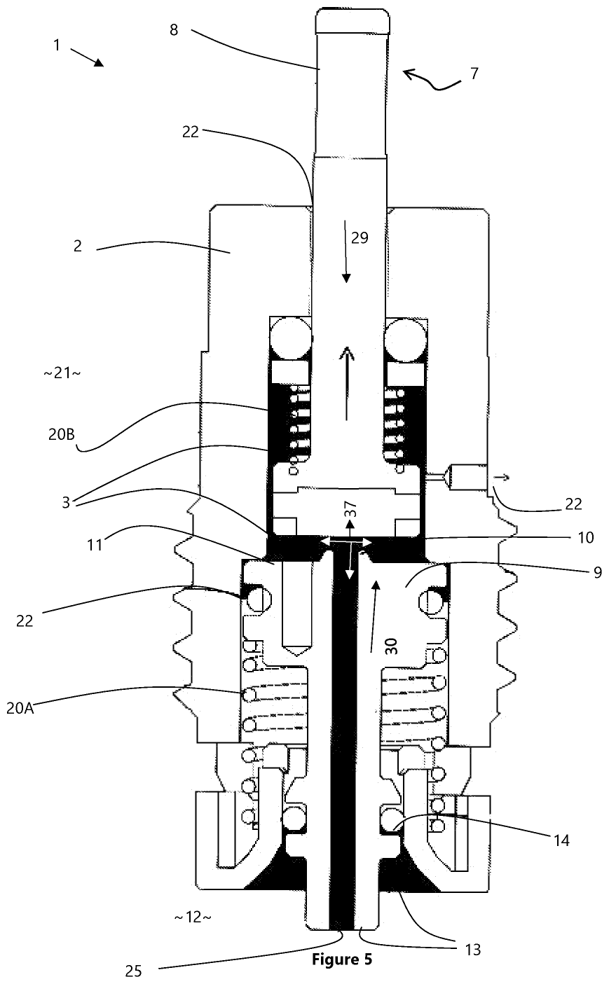

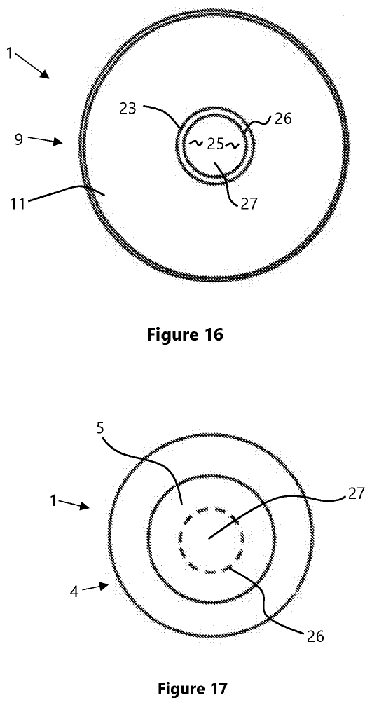

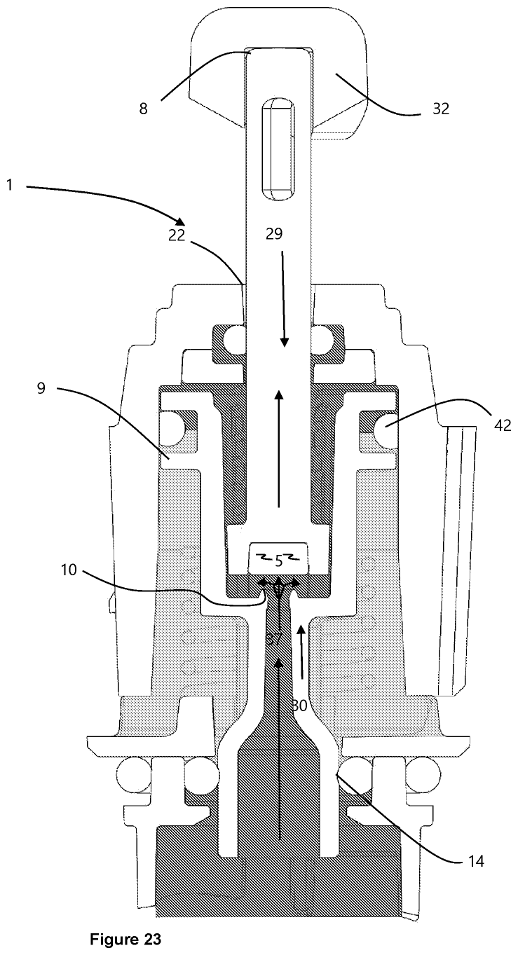

The primary sealing portion 10 has a knife edge 23 that is a raised endless region of the primary sealing portion 10 more clear in side view in FIG. 5 and FIG. 22 and in FIGS. 16 and 17. In the variation shown the knife edge is circular in shape, for example as shown in FIG. 16. However, any shape, preferably of closed form, will work.

Through the trigger piston 9 there is a pilot port 25 through it from the high pressure fluid 12 region to the primary sealing portion 5. In the resting position of the trigger valve 1 the pilot port 25 is sealed by the sealing engagement of the tripper poppet 4 and trigger piston 9.

The side of the trigger piston 9 can contain a trigger piston seal 42, that can tune, if needed any leak path 22 between the side of the trigger piston 9 and the interior surface of the cavity 3. Again such a leak path 22 can be used to tune the trigger valve 1, including its response time, including movement of the trigger piston 9 away from the rest position, and its return.

The trigger piston 9 extends to provide a secondary sealing portion 14 toward its second end 18. In the variation shown in FIGS. 1 through 11 and 14 the secondary sealing portion 14 seals to the housing 2, or part connected thereto, for example part of the device 16 which the trigger valve 1 is connected to. The secondary sealing portion 14 as shown in FIG. 1 is an o-ring within a seat on or towards the second end 18 of the trigger piston 9. The inner diameter of the o-ring seals to the trigger piston, while the outer diameter, when in the rest position as shown in FIG. 1 seals to the inner diameter of the housing, or part thereof.

The inner diameter of the housing as shown in FIG. 1 has a throat 35 which tapers from a larger diameter to the diameter that seals with the second sealing portion 14. This helps with flow of the high pressure fluid 12, and also guides the second sealing portion 14 into and out of the sealing engagement therewith.

The upper portion (when viewed in FIG. 1) of the second sealing portion 14 is also tapered 34. This helps guide, with or without the throat 35, the trigger piston 9 when moving from the rest position to the open position and back again.

In the variation shown in FIGS. 18 through 30 the secondary sealing portion 14 is present and seals to the housing 2, or part connected thereto, for example part of the device 16 which the trigger valve 1 is connected to, but is reversed. That is, the o-ring is located on the housing 2 or part thereof, and the sealing surface is on or towards the second end 18 of the trigger piston 9.

The secondary sealing portion 14 as shown in FIG. 20 is the throat 35 or variation in diameter on or towards the second end 18 of the trigger piston 9 which changes from a smaller diameter part way along to the greater diameter at the far end 18 that seals with the oring in the housing, or part thereof. This throat in this variation again helps with flow of the high pressure fluid 12, and also guides the second sealing portion 14 into and out of the sealing engagement therewith, providing a gradual lower friction sealing due to the gradual change to and from the greater sealing diameter, shown in sealing in FIG. 18.

The inner diameter of the o-ring seals to the outer diameter of the throated area of the trigger piston when in the rest position as shown in FIG. 18, while the outer diameter of the o ring seals to the inner diameter of the housing, or part thereof. Again the tapering, throating, or change in diameter of the second end 18 helps guide the trigger piston 9 when moving from the rest position to the open position and back again.

The trigger piston 9 has an extension 36 at its second end. This may, in some embodiments allow it to impact on a device or part thereof when actuated.

There is a further bias 20A shown in FIGS. 1 and 18 that acts on the trigger piston 9. This acts on the trigger piston 9 to urge it towards the rest or ready position, that is towards sealing engagement with the trigger poppet 4. This is optional, and may be necessary to help tune the trigger valve performance to augment the closing force provided by the high performance fluid 12 when acting on the minor face 13. The bias 20A may be retained as part of the trigger valve 1, or may be separate and is retained between the trigger valve 1 and the device 16, when the trigger valve 1 is engaged or otherwise retained to the device 16.

The housing 2 itself may engage or be held to the device 16 in any one of a number of ways. In FIGS. 1 to 11 it is shown as threaded, with a thread profile on the exterior of the housing 2. In FIGS. 18 through 30 it is held by pins However, in either form the engagement and retention method is interchangeable, and, in other forms it may be held in position by other means, for example a clamp, or retaining pins as shown in FIG. 14. The trigger valve 1 may also act as an over pressure relief valve. The trigger valve 1 may be actuated by an external input, such as when an over pressure event is detected, via the receiving end 8, much like the trigger bar does. Alternatively the trigger valve 1 may b actuated by the high pressure fluid 12 through the pilot port 25 exceeding the sealing pressure of the biases 20A and 20B and unseal the primary sealing portion 10. In this way high pressure fluid can be released via vents 46 to ambient pressure.

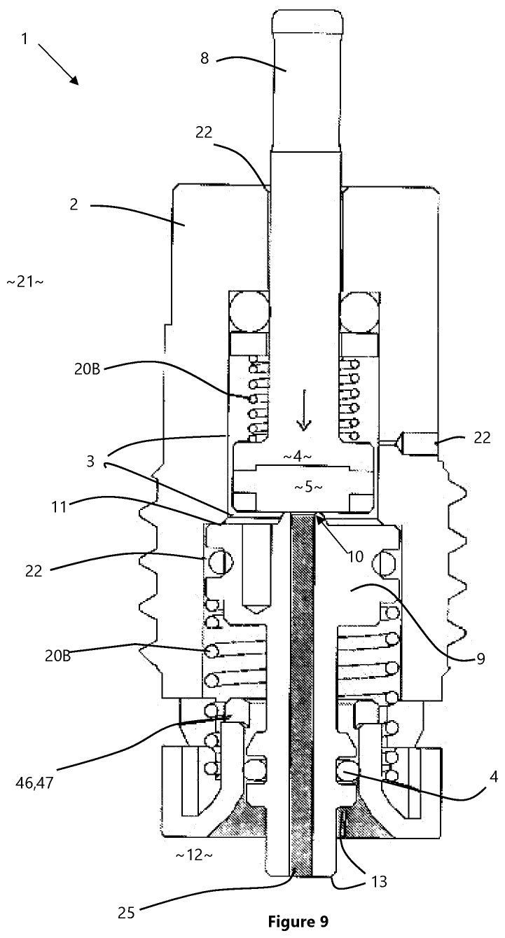

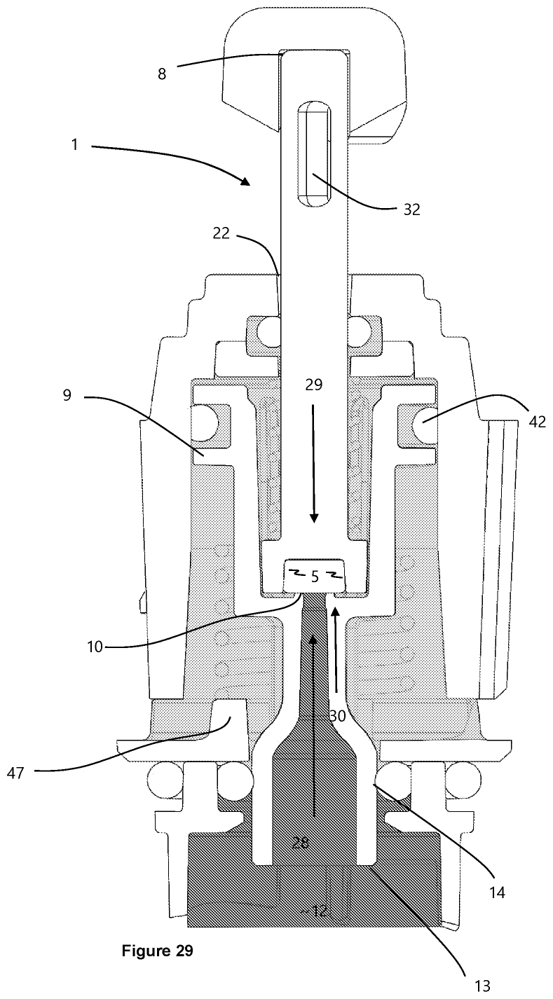

At or near the vents 46 there is an interrupted structure such as a flute 47 shown in FIGS. 9 and 29 to provide a clear path to exhaust the high pressure fluid to ambient—this prevents, for example the bias 20B from sealing off the vent as the the bias compresses—the structure of the flute 47 is evident when either side is compared in FIG. 29.

Various leak paths are shown as 1 to 5, and in particular detailed in FIG. 28, and can be formed also in the version shown in FIGS. 1 to 11. The leak paths are
1. Leak via poppet (top) seal
2. Leak via piston seal
3. Leak via pinhole through side wall
4. Leak via pinhole through piston
5. Leak through a pinhole through the poppet itself.

There is also clear a change in thickness of secondary sealing in FIGS. 19, 20, 22, 24, compared to 21, 23, and 25-30. This is shown to illustrate how this can be used at least to change the response time of the trigger valve 1.

The method of operation of the trigger valve will now be described with reference to FIGS. 1 to 11, and FIGS. 18 to 32.

The trigger valve at rest is shown in FIGS. 1, 4, 19, 20, and 21, and eventually again at 29 and 30. The trigger poppet 4 and trigger piston 9 are in sealing engagement 15 on their respective poppet sealing portion 5 and primary sealing portion 10. The sealing engagement 15 is held in place by the action of a second force 29 from the bias 20B acting on the trigger poppet 4 acting against a third force 30 from the high pressure fluid 12 acting on the minor face 13 with, and fifth force 39 if the bias 20A is present.

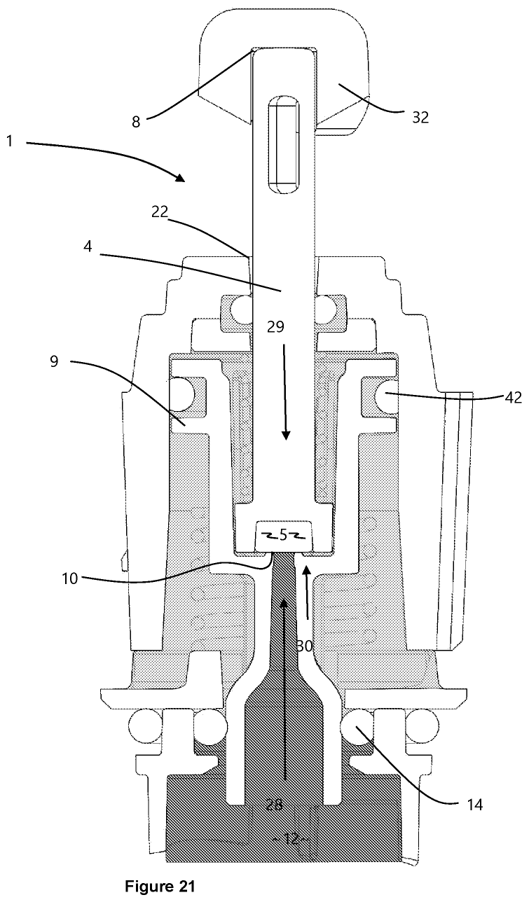

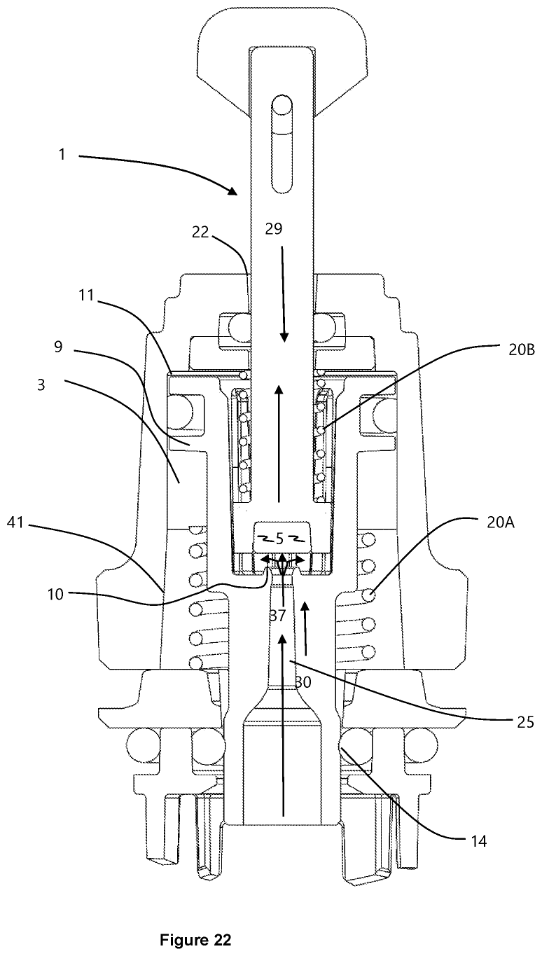

The high pressure fluid 12 (brown or dark in FIGS. 4 and 21) acting through the pilot port and within the sealing periphery 26 forms a first force 28 which is exceeded by the second force 29.

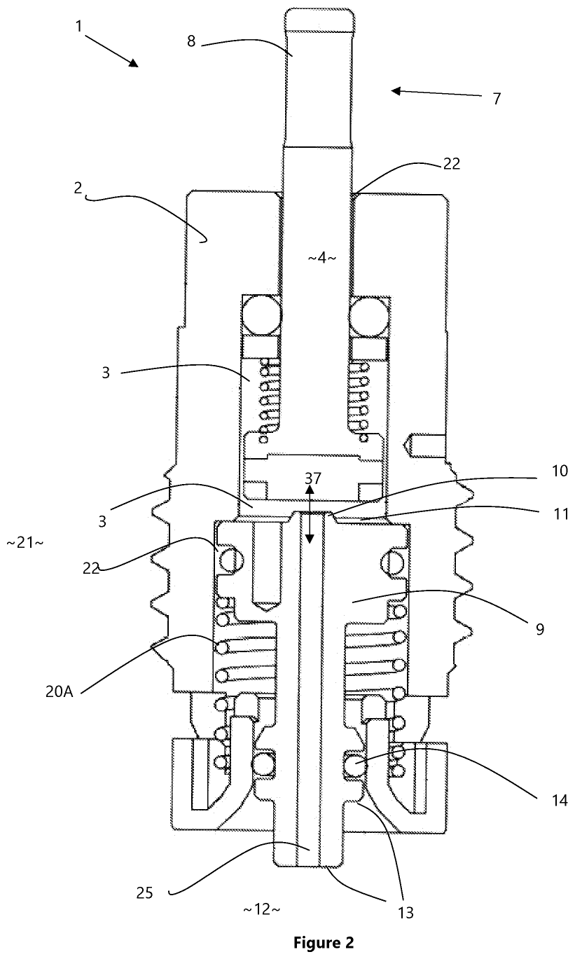

Once the trigger poppet is disturbed by the external input 7 as shown in FIGS. 2, 5,22 and 23 the sealing engagement 15 is unseated. This allows high pressure fluid 12 to rush in forming, or increasing the cavity 3A between the poppet sealing portion 5 and primary sealing portion 10. This creates a fourth force 37 when the high pressure fluid 12 can now acts on the major face 11.

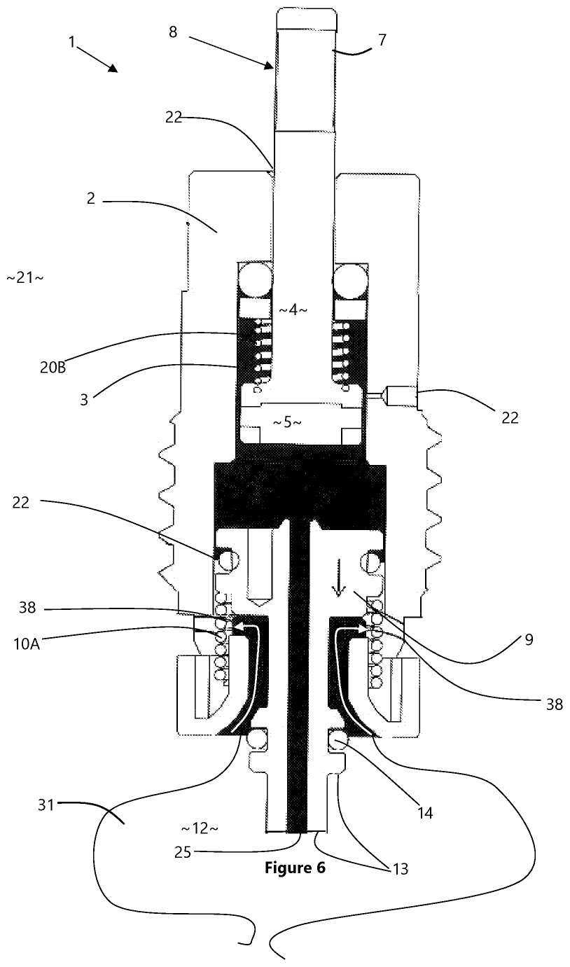

This fourth force 37 exceeds the third force 30 and fifth force 39 and drives the trigger piston 9 open, downwards in the case of FIGS. 3, 6, 22 and 23. At, or towards this extent of travel of the trigger piston 9, the secondary sealing portion 14 is unseated, allowing the high pressure fluid 12 to move as shown in FIGS. 6, 24 and 25 through release ports 38.

The large flow area that is exposed when the trigger piston's secondary sealing portion 14 is unseated allows fast flow of high pressure 12 out of the high pressure volume 31 as seen in FIGS. 3, 7 and 25. Such an exhausting can be used in several ways. Releasing the pressure in the high pressure volume may be in the form of a dump chamber that then allows another action. For example, a driven chamber that is supplied with high pressure fluid on one side of another piston, and the dump chamber on the other side of the another piston. Dumping the high pressure air from the dump chamber, then allows the high pressure fluid in the driven chamber to drive the another piston to perform an action.

In addition or, in another way, the high pressure fluid escaping the release ports 38 may then also do work. As earlier mentioned the release may also be a venting of over pressure in the high pressure source, either externally actuated, or initiated by the high pressure 12 exceeding the sealing force between 5 and 10.

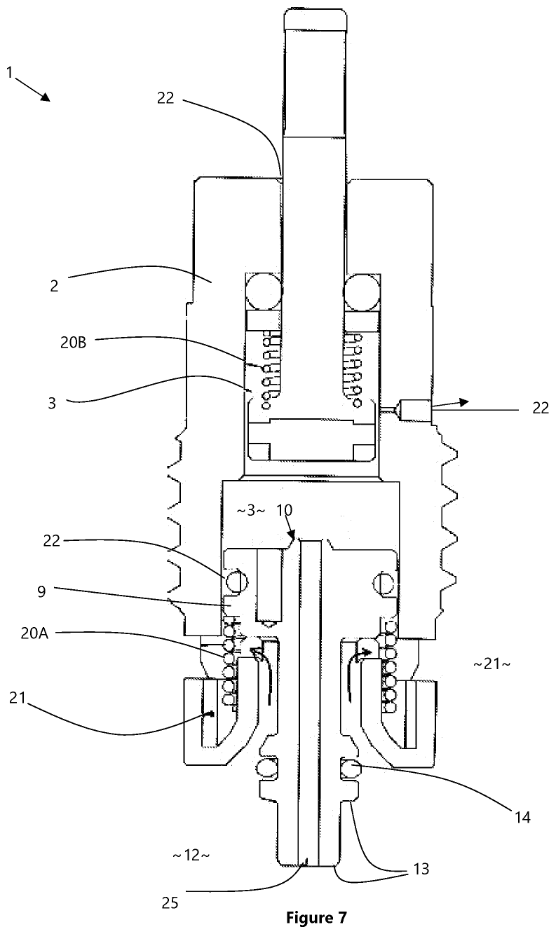

The high pressure fluid now vented from the high pressure volume 31 reduces in pressure, which in turn means the pressure in the cavity 3 in FIGS. 7 and 26 formed between the trigger poppet 4 and the trigger piston 9 can then vent via the pilot port 25 and release ports 38 to ambient or reference pressure 21.

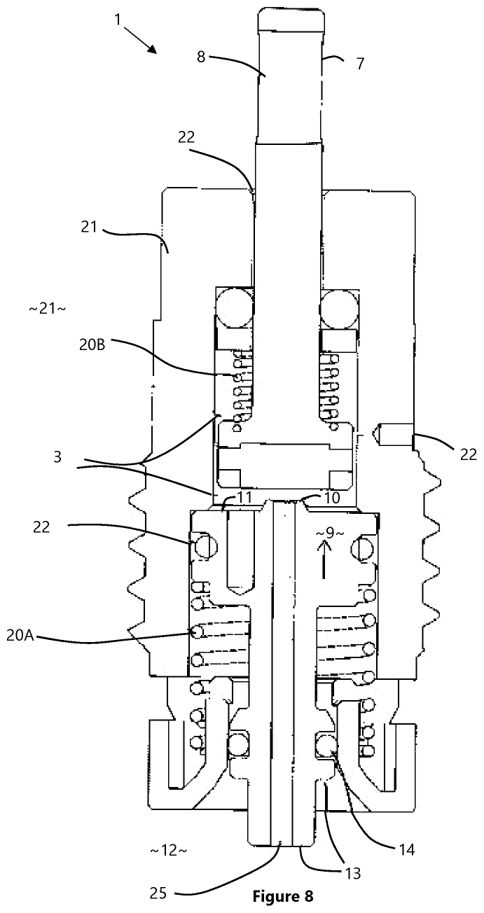

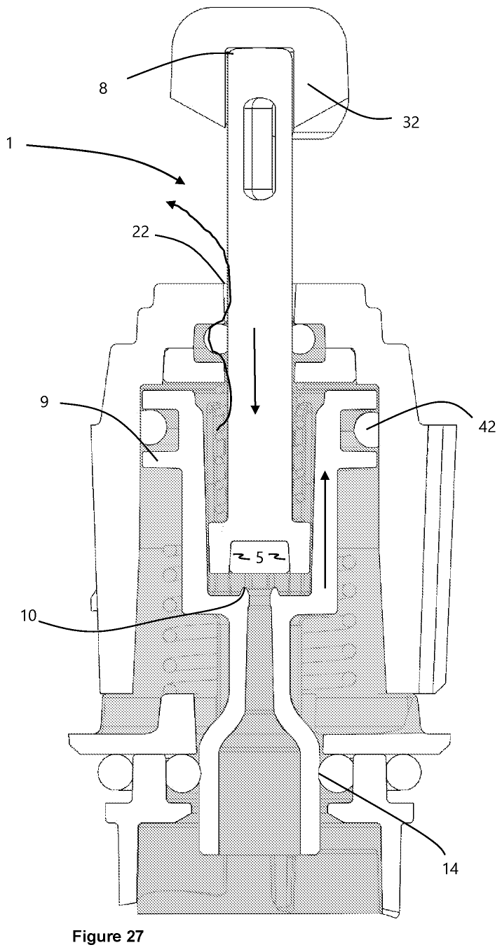

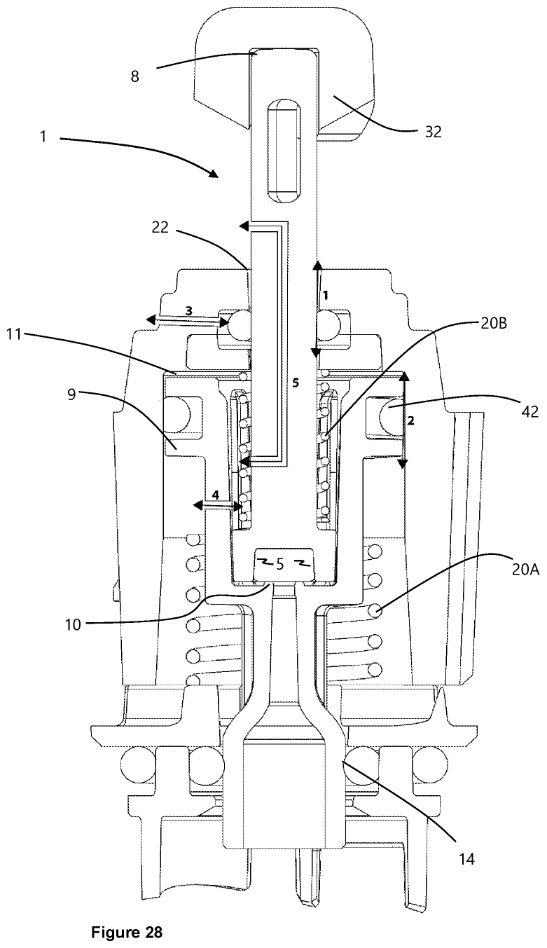

Once the fourth force 37 reduces below that provided by the third force 30 and fifth force 39 then forces 30 and 39 will start to move the trigger piston 9 back toward the rest position, as shown in FIGS. 8 and 27. Likewise, when the fourth force 37 falls below the second force 29, then the trigger poppet 4 will also start to move back towards the rest position, as shown in FIGS. 8 and 27—these movements may occur before, after or at the same time as each other. The moving of the tripper poppet 4 and trigger piston 9 towards each other and the rest position will therefore aid in venting the cavity 3 between them. Various leak paths 1 through 5 are shown in FIG. 28 to allow this.

The relative movement of the trigger poppet 4 and trigger piston 9 towards each other continues under action of the second force 29 and the third force 30 until the two are once again in sealing engagement as shown in FIGS. 9 and 29.

The pressure in the high pressure volume 31 then increases back to the set pressure, feeds the pilot port 25 and the trigger valve 1 is now ready to fire again.

The high pressure volume 31 may be fed by high pressure fluid 12 in several ways. For example this may be a throttled flow, or a selectively switched flow, either being from a supply, source or reservoir of high pressure fluid.

A throttled flow would be incapable of filling the volume of high pressure fluid that is dumped when the trigger valve 1 is open volume. Instead, it supplies high pressure fluid at a rate that slow, or extremely slow in comparison to the trigger valve flow rate, so in practice the trigger valve will reach almost reach ambient just from the trigger valve outflow when open to ambient 21.

A switched flow in contrast is controlled by a separate valving component linked to either the external input e.g. trigger bar, or the position of a component controlled by the trigger valve. For example, the workload position may control the flow into the dump chamber. The switched flow will open to supply a charge of high pressure fluid to the high pressure volume 31 and trigger valve 1 and then close again.

However, when the trigger valve 1 is closed again the throttled flow, or switched flow, will quickly fill the high pressure volume 31 and the pilot port 25 again, that filling rate dictated by the required cycle rate of the system into which the trigger valve is installed.

The trigger valve may also include a low pressure lock out, such that it, or the device is not actuated if the high pressure fluid supplied to it is below a certain set pressure. Such a set pressure may for example be that pressure below which the device may not operate within the required parameters. The biases 20A and, or 20B may be of such a stiffness that the second force 29 and third force 30 they create will prevent the unsealing of the sealing engagement, even when an external input is received, if the pressure of the high pressure fluid is below a set threshold, the high pressure flooding in will not open the trigger valve 1.

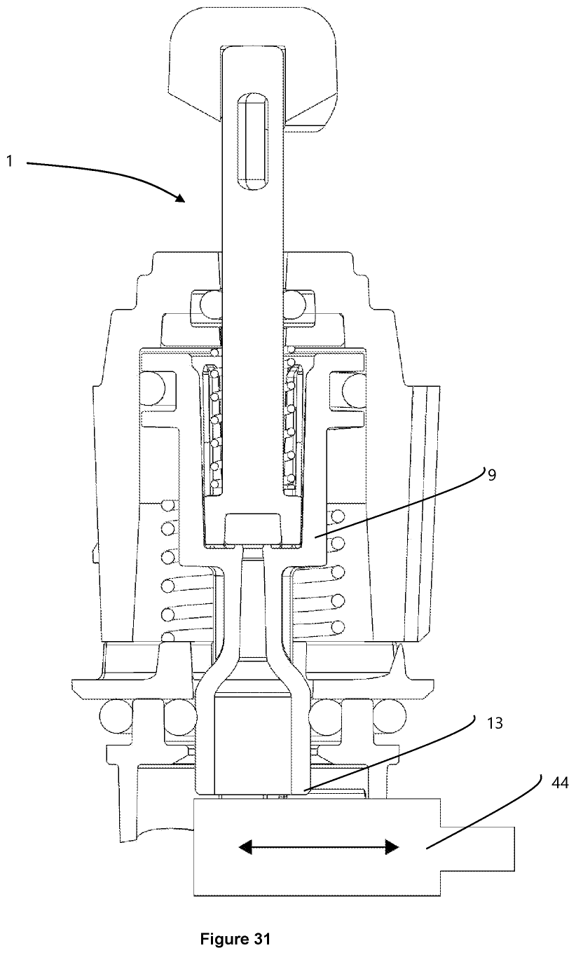

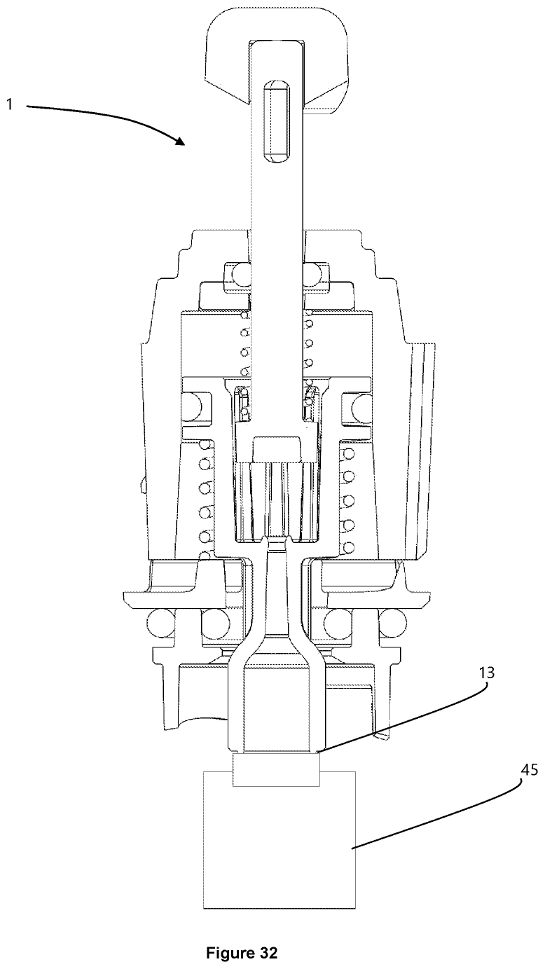

The trigger valve may also include a physical lockout, for instance, a movable body as a blocking portion 44 as shown in FIGS. 14 and 31 positionable immediately adjacent minor face 13 to restrict the trigger piston 9 from moving to it's open state. This allows for the trigger valve to be put into a safety or lock out mode to enable safe handling for example for maintenance.

Another method of operation of the trigger valve 1 may be where the trigger poppet 4, being force balanced to seal against the top of the trigger piston 9 by default, can be made to act as a check valve. In this method the trigger valve will only allow flow through the pilot port 25 in one direction, meaning that in that force balance arrangement, the only flow path out of the housing would be via a leak path or restricted flow path. To achieve this the pressure areas are adjusted to tune for the correct release pressure.

An example of use of the present invention is described with reference to FIGS. 12 through 15. The device 16 in this instance operates on high pressure gas, such as, but not limited to air and performs the function of a pest control device, or trap.

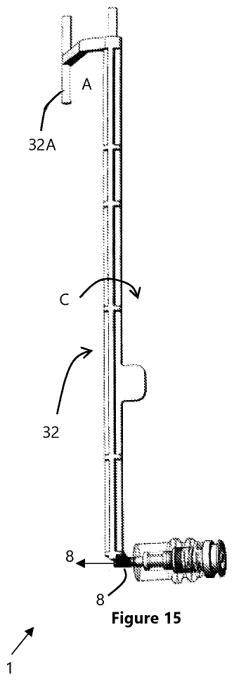

The pest, for example a rodent, enters the trap and interacts with a trigger 32A in FIG. 15, moving it in the direction A shown causing the trigger bar 32 rotate C as shown. A user may also for example activate the trigger bar 32 by touching it, where indicated, to test it.

Both such movements of the trigger bar will cause a movement B at the trigger valve, for example as shown in FIG. 14, at the receiving end 8 of the trigger poppet 4. This will create the external input 7 that is necessary to fire the trigger valve 1. The trigger valve will then cause high pressure fluid to act on components of the trap to then drive a piston which impacts the rodent to then incapacitate or kill it humanely. In the implementation shown the dumping of high pressure fluid by the trigger valve 1 establishes a pressure imbalance across a hammer. This hammer is then driven by the pressure imbalance to do work and fire the trap. So in this implementation the trigger valve 1 once triggered sets up a pressure bias which then does work.

The reset time of the trigger valve 1 in this operation is within the range of 20 to 500 milliseconds.

A pilot sealing portion 45 may also be present to seal off the high pressure fluid 12 from escaping up the pilot port 25 when the trigger piston 9 is displaced and open. This prevents a continuous flow of high pressure fluid to ambient when the trigger valve is open, and only a small dose can escape being sufficient to do or cause work to be done.

The foregoing description of the invention includes preferred forms thereof. Modifications may be made thereto without departing from the scope of the invention.

1. A trigger valve, comprising or including,
A housing enclosing, at least in part, a cavity,
A trigger poppet including a poppet sealing portion at least in part within the cavity, the trigger poppet configured to receive an external input at, or toward, a receiving end thereof,
A trigger piston including a primary sealing portion and a major face at least in part within the cavity, the trigger piston configured to receive high pressure fluid therethrough, the trigger piston having a minor face opposite the major surface and a secondary sealing portion,
Wherein the trigger poppet and trigger piston are biased towards each other at least by the high-pressure fluid acting on the minor face, such that the high-pressure fluid is sealed from the cavity by the poppet sealing portion and primary sealing portion in sealing engagement on each other;
The secondary sealing portion sealing against the housing, or part thereof, preventing release of the high-pressure fluid therefrom, and
the poppet sealing portion when displaced from the primary sealing portion by the external input unseals the sealing engagement and allows high pressure fluid to flow into the cavity and act on the major face causing the trigger poppet to move and unseats the secondary sealing portion from the housing, or part thereof, to allow flow of high pressure fluid to then do work, or cause work to be done.

2. A trigger valve as claimed in claim 1 wherein the work is in the form of the high-pressure fluid acting on a first external device, such as, but not limited to another surface, valve, dose valve, or similar.

3. A trigger valve as claimed in claim 1 or 2 wherein the trigger piston has a second end, opposite and distal from a first end that has the primary sealing portion, that can act on the first external, or a second external device.

4. A trigger valve as claimed in claim 3 the second end can act as a hammer to impact on the first, or second, external device.

5. A trigger valve as claimed in any one of claims 1 to 4 wherein the trigger piston moves in a first direction within the cavity.

6. A trigger valve as claimed in any one of claims 1 to 4 wherein the trigger poppet moves in a second direction within the cavity.

7. A trigger valve as claimed in claims 5 and 6 wherein the first direction and second direction are parallel to each other.

8. A trigger valve as claimed in any one of claims 1 to 7 wherein the major face and minor face are each perpendicular to the first direction.

9. A trigger valve as claimed in any one of claims 1 to 8 wherein the receiving end is distal from the primary sealing portion.

10. A trigger valve as claimed in any one of claims 1 to 9 wherein the trigger poppet is surrounded by, and the cavity filled by, ambient pressure, which may be atmospheric, environmental or another reference pressure when in sealing engagement.

11. A trigger valve as claimed in any one of claims 1 to 10 wherein the trigger piston and, or the trigger poppet, are further biased toward the sealing engagement by one or more biasing elements, such as, but not limited to a spring, or other elastic element, whether in tension or compression.

12. A trigger valve as claimed in any one of claims 1 to 11 wherein the cavity includes one or more leak paths from an interior thereof to an exterior thereof, such as, but not limited to bleed ports, or less than perfect sealing about the trigger poppet, trigger piston, or parts thereof.

13. A trigger valve as claimed in any one of claims 1 to 12 wherein the primary sealing portion is an endless knife edge and the poppet sealing portion seals thereto, either or both being a resilient material to at least in part conform and seal to the other, or vice versa.

14. A trigger valve as claimed in any one of claims 1 to 13 wherein there is a pilot port through the trigger piston to within a sealing periphery formed between the primary sealing portion and poppet sealing portion.

15. A trigger valve as claimed in any one of claims 1 to 14 wherein a sealing area contained within the sealing periphery creates a first force from the high-pressure fluid, that is less than a second force created by the bias acting on the trigger poppet, such that the sealing engagement is maintained.

16. A trigger valve as claimed in any one of claims 1 to 15 wherein there is a third force from the high-pressure fluid acting on the minor face including with any further bias, when in sealing engagement.

17. A trigger valve as claimed in any one of claims 1 to 16 wherein the second force and third force drive the two portions together to form the sealing engagement.

18. A trigger valve as claimed in any one of claims 1 to 17 wherein the high-pressure fluid creates a fourth force when acting on the major face that is greater than the third force including any further bias.

19. A trigger valve as claimed in any one of claims 1 to 18 wherein the high-pressure fluid is fed from a high-pressure fluid volume.

20. A trigger valve as claimed in any one of claims 1 to 19 wherein the high-pressure fluid volume is supplied from a high-pressure fluid source, either constantly, or selectively.

21. A trigger valve as claimed in any one of claims 1 to 20 wherein the selective supply is closed, or closes, when the sealing engagement is unsealed, and, or when the secondary sealing portion is unseated.

22. A trigger valve as claimed in any one of claims 1 to 21 wherein, the constant supply from the high-pressure fluid source is at a first flow rate that is lower than a second flow rate when the sealing engagement is unsealed and, or the secondary sealing portion is unseated.

23. A trigger valve as claimed in any one of claims 1 to 22 wherein the high-pressure fluid is in the range of 10 to 50 bar, and ideally at around 16 bar.

24. A trigger valve as claimed in any one of claims 1 to 23 wherein the interior of the cavity can exhaust high pressure fluid back through the pilot port into the high-pressure volume when unsealed.

25. A trigger valve as claimed in any one of claims 1 to 24 wherein the high pressure fluid pressure acting on the major face will reduce after unsealing, as the high pressure fluid does work when the secondary sealing portion is unseated, such that the fourth force reduces to below the third force, allowing the trigger piston to be biased back towards sealing engagement.

26. A trigger valve as claimed in any one of claims 1 to 25 wherein unseating of the secondary sealing portion allows the high-pressure fluid to vent to ambient.

27. A trigger valve as claimed in any one of claims 1 to 26 wherein the trigger poppet is driven in the second direction, opposite to the first direction, when unsealed, by the high-pressure fluid, acting on the poppet sealing portion.

28. A trigger valve as claimed in any one of claims 1 to 27 wherein the trigger poppet has at least a first partial seal where any part of it extends beyond the cavity.

29. A trigger valve as claimed in any one of claims 1 to 28 wherein the trigger piston has at least a second partial seal between a periphery thereof and the interior of the cavity.

30. A trigger valve, comprising or including,
A valve body, with an interior thereof defining a cavity,
A trigger poppet, at least in part located within the cavity,
A trigger piston, at least in part located within the cavity,
The trigger poppet and the trigger piston having,
first positions where they are biased to be in sealing engagement with each other, such that a supply of high-pressure fluid is prevented from entering between them, and
second positions where receipt of an external input unseals the sealing engagement, the high-pressure fluid can enter between them, forcing them apart, such that a flow of high pressure fluid is released to then do work, or cause work to be done, on an external device.

31. A trigger valve that operates on a high-pressure fluid, comprising or including,
A valve housing, the valve body defining a pressure cavity,
A primary trigger poppet that can receive an external input, and having a first poppet sealing surface or portion located within the pressure cavity,
A secondary trigger piston that can act on an external device, and having a primary sealing surface or portion, the secondary trigger piston can receive a source of the high pressure fluid, which high pressure fluid is sealed at a sealing engagement of the first poppet sealing surface, and primary sealing surface,
the primary trigger poppet and secondary trigger piston biased towards sealing engagement at the first poppet sealing surface, and primary sealing surface,
upon receipt of the external input the first poppet sealing surface is displaced from the sealing engagement, and the high-pressure fluid can flow into an interior of the pressure cavity to then displace the secondary trigger piston to then act, or cause an action, on the external device.

32. A method of operation of a trigger valve, comprising or including the steps of,
Providing a housing having a cavity therein, at least in part within which there is a trigger poppet, and a trigger piston,
Biasing the trigger poppet and the trigger piston at least in part by a high pressure fluid such that in a first position they are in sealing engagement with each other so that the high pressure fluid is prevented from moving between them, and wherein a flow of high pressure fluid is prevented from exiting the housing, or part thereof,
Disturbing the trigger poppet, and or the trigger piston by an external input such that the they move to a second position where high pressure fluid can flow therebetween and drive them apart,
allowing the flow of high-pressure fluid, when the trigger poppet and or the trigger piston move to or toward the second position, to exit the housing, or part thereof,
working on an external device by the flow of high pressure exiting the housing, or part thereof,
exhausting the high-pressure fluid between the trigger poppet and trigger piston such that the trigger poppet and, or trigger piston can return, under the, or another bias, to the first position,
such that the trigger valve allows or causes an instance of work to be done by the high-pressure fluid on an external device, in response to an external input, and thereafter reset itself in preparation for a further external input.

33. A method as claimed in claim 32 wherein the work is in the form of the high-pressure fluid acting on a first external device, such as, but not limited to another surface, valve, dose valve, or similar.

34. A method as claimed in claim 31 or 32 wherein the trigger piston has a second end, opposite and distal from a first end that has the primary sealing portion, that can act on the first external, or a second external device.

35. A method as claimed in claim 34 the second end can act as a hammer to impact on the first, or second, external device.

36. A method as claimed in any one of claims 32 to 35 wherein the trigger piston moves in a first direction within the cavity.

37. A method as claimed in any one of claims 32 to 36 wherein the trigger poppet moves in a second direction within the cavity.

38. A method as claimed in claims 36 and 37 wherein the first direction and second direction are parallel to each other.

39. A method as claimed in any one of claims 32 to 38 wherein the major face and minor face are each perpendicular to the first direction.

40. A method as claimed in any one of claims 32 to 39 wherein the receiving end is distal from the primary sealing portion.

41. A method as claimed in any one of claims 32 to 40 wherein the trigger poppet is surrounded by, and the cavity filled by, ambient pressure, which may be atmospheric, environmental or another reference pressure when in sealing engagement.

42. A method as claimed in any one of claims 32 to 41 wherein the trigger piston and, or the trigger poppet, are further biased toward the sealing engagement by one or more biasing elements, such as, but not limited to a spring, or other elastic element, whether in tension or compression.

43. A method as claimed in any one of claims 32 to 42 wherein the cavity includes one or more leak paths from an interior thereof to an exterior thereof, such as, but not limited to bleed ports, or less than perfect sealing about the trigger poppet, trigger piston, or parts thereof.

44. A method as claimed in any one of claims 32 to 43 wherein the primary sealing portion is an endless knife edge and the poppet sealing portion seals thereto, either or both being a resilient material to at least in part conform and seal to the other, or vice versa.

45. A method as claimed in any one of claims 32 to 44 wherein there is a pilot port through the trigger piston to within a sealing periphery formed between the primary sealing portion and poppet sealing portion.

46. A method as claimed in any one of claims 32 to 45 wherein a sealing area contained within the sealing periphery creates a first force from the high-pressure fluid, that is less than a second force created by the bias acting on the trigger poppet, such that the sealing engagement is maintained.

47. A method as claimed in any one of claims 32 to 46 wherein there is a third force from the high-pressure fluid acting on the minor face including with any further bias, when in sealing engagement.

48. A method as claimed in any one of claims 32 to 47 wherein the second force and third force drive the two portions together to form the sealing engagement.

49. A method as claimed in any one of claims 32 to 48 wherein the high-pressure fluid creates a fourth force when acting on the major face that is greater than the third force including any further bias.

50. A method as claimed in any one of claims 32 to 49 wherein the high-pressure fluid is fed from a high-pressure fluid volume.

51. A method as claimed in any one of claims 32 to 50 wherein erably the high-pressure fluid volume is supplied from a high-pressure fluid source, either constantly, or selectively.

52. A method as claimed in any one of claims 32 to 51 wherein the selective supply is closed, or closes, when the sealing engagement is unsealed, and, or when the secondary sealing portion is unseated.

53. A method as claimed in any one of claims 32 to 52 wherein, the constant supply from the high-pressure fluid source is at a first flow rate that is lower than a second flow rate when the sealing engagement is unsealed and, or the secondary sealing portion is unseated.

54. A method as claimed in any one of claims 32 to 53 the high-pressure fluid is in the range of 10 to 50 bar, and ideally at around 16 bar.

55. A method as claimed in any one of claims 32 to 54 wherein the interior of the cavity can exhaust high pressure fluid back through the pilot port into the high-pressure volume when unsealed.

56. A method as claimed in any one of claims 32 to 55 wherein the high pressure fluid pressure acting on the major face will reduce after unsealing, as the high pressure fluid does work when the secondary sealing portion is unseated, such that the fourth force reduces to below the third force, allowing the trigger piston to be biased back towards sealing engagement.

57. A method as claimed in any one of claims 32 to 56 wherein unseating of the secondary sealing portion allows the high-pressure fluid to vent to ambient.

58. A method as claimed in any one of claims 32 to 57 wherein the trigger poppet is driven in the second direction, opposite to the first direction, when unsealed, by the high-pressure fluid, acting on the poppet sealing portion.

59. A method as claimed in any one of claims 32 to 58 wherein the trigger poppet has at least a first partial seal where any part of it extends beyond the cavity.

60. A method as claimed in any one of claims 32 to 59 wherein the trigger piston has at least a second partial seal between a periphery thereof and the interior of the cavity.

61. A trigger valve as described herein with reference to any one or more of the accompanying drawings.

62. A method of operating of a trigger valve as described herein with reference to any one or more of the accompanying drawings.

63. A device incorporating a trigger valve as herein described with reference to any one or more of the accompanying drawings.
